(19) United States
(12) Patent Application Publication
(10) Pub. No.: US 2016/0090481 A1
(43) Pub. Date: Mar. 31, 2016

(54) HALOGEN-FREE FLAME-RETARDANT THERMOPLASTIC POLYESTERS

(71) Applicant: LANXESS Deutschland GmbH, Cologne (DE)

(72) Inventors: Jochen Endtner, Cologne (DE); Matthias Bienmuller, Krefeld (DE); Martin Wanders, Odenthal (DE)

(73) Assignee: LANXESS DEUTSCHLAND GMBH, Cologne (DE)

(21) Appl. No.: 14/943,389

(22) Filed: Nov. 17, 2015

Related U.S. Application Data
(63) Continuation of application No. 12/083,185, filed on Apr. 4, 2008, now abandoned.

(30) Foreign Application Priority Data
Oct. 25, 2005 (DE) 10 2005 050 956.8

(51) Int. Cl. C08L 67/00

(52) U.S. Cl. CPC C08L 67/00

(57) ABSTRACT

The present invention relates to halogen-free flame-retardants for thermoplastic polyesters with UL 94 V-0 classification and with particularly good mechanical properties and high tracking resistance.

The present patent application is a continuation of pending U.S. patent application Ser. No. 12/083,185 filed Apr. 4, 2008, entitled “HALOGEN-FREE FLAME RETARDANT THERMOPLASTIC POLYESTER”, which claims the right of priority under 35 U.S.C. §119(a)-(d) and 35 U.S.C. §365 of International Application No. PCT/EP2006/009860, filed 12 Oct. 2006, which was published in German as International Patent Publication No. WO 2007/048509 A1 on 3 May 2007, and is entitled to the right of priority of German Patent Application No. DE 10 2005 050 956.8, filed on 25 Oct. 2005.

The present invention relates to halogen-free flame-retardants for thermoplastic polyesters with UL 94 V-0 classification and with particularly good mechanical properties and high tracking resistance.

The UL 94 test was developed by Underwriters Laboratories in the USA and is concerned with dripping of polymer melts. A specimen (127 mm×12.7 mm×12.7 mm) arranged vertically is ignited (10seconds) here with a Bunsen burner (19 mm flame). If the flame becomes extinguished after less than 30 seconds, the specimen is again ignited for 10 seconds. At second ignition stage, flame retardants which are too volatile are no longer available, and the polymer melt produced during combustion drips onto a cotton pad. If this is not ignited by the burning melt, and if the afterflame time for the specimen is less than 5 seconds, its classification is UL 94 V-0. If the afterflame time is the same, but the cotton pad burn, the relevant classification is UL 94 V-2.

Many plastics are flammable by virtue of their chemical constitution. Plastics therefore generally have to be equipped with flame retardant so that they can reach the stringent flame retardancy requirements demanded by plastics processors and sometimes by legislation. A wide variety of flame retardants and flame retardant synergists is known and also commercially available for this purpose. For some time, preference has been given to use of non-halogenated flame retardant systems not only for environmental reasons but also because they perform better in terms of the smoke density and smoke toxicity associated with fires.

Among the non-halogenated flame retardants, the salts of phosphinic acids (phosphinates) in particular have proven to have particular effectiveness for thermoplastic polyesters. DE-A-2252258 (=U.S. Pat. No. 3,900,444) therefore describes alkali metal salts of phosphinic acids e.g. sodium dimethylphosphinate or disodium ethylenebis(methylphosphinate) as effective flame retardant components. However, amounts of tip to 30% by weight of these have to be introduced and they sometimes exhibit a disadvantageous effect of accelerated corrosion of processing machinery.

The salts of phosphinic acids with a metal of the second or third main or transition group of the periodic table of the elements have also been used in thermoplastic polyesters.

When compared with other halogen-free flame retardants, e.g. triphenyl phosphate, resorcinol bis(diphenyl phosphate) (RDP) or bisphenol A bis(diphenyl phosphate) (BDP) they in particular feature good properties after heat-ageing (US-A-2005 013 7297).

Combinations of the phosphinic salts mentioned with nitrogen-containing flame retardant synergists have also been described (EP-A-0 006 568), and certain nitrogen compounds with relatively high thermal stability and relatively low volatility have proven particularly advantageous here, examples being melamine cyanurate, melamine phosphate, benzoguanamine, dimelamine phosphate, tris(hydroxyethyl) isocyanurate, allantoin, glycoluril, melamine pyrophosphate and urea cyanurate (EP-B-0892829/U.S. Pat. No. 6,365,071).

Among the phosphinic salts mentioned, organic calcium phosphinates and organic aluminium phosphinates, e.g. calcium bis[ethylmethylphosphinate] or aluminium tris[ethylmethylphosphinate] have proven particularly effective with regard to flame retardant action, also in particular in comparison with zinc phosphinates (EP 0 699 708 B1/U.S. Pat. No. 5,780,534).

However, the calcium phosphinates and aluminium phosphinates mentioned are solids which—unlike some zinc phosphinates—do not melt under conventional processing conditions (EP-A-1 454 912/US 2 004 176 506). This makes homogeneous incorporation into moulding compositions much more difficult. A first consequence of this is that use in thin-walled items, such as films, foils and fibres, and even to some extent thin-wailed components, is subject to severe limitation. A second consequence is that the mechanical properties of polyesters using calcium phosphinates or aluminum phosphinates as flame retardant are far inferior to those of conventional halogen-containing comparative products, in particular with regard to the properties particularly important for the electrical sector: tensile strain (ISO 527 tensile test or ISO 178 flexural test) and impact resistance (e.g. ISO 180). The solid character of the phosphinates mentioned can moreover have an adverse effect on the melt viscosity of the moulding composition. Another critical point that must also be mentioned is that the tracking resistances described (EP-B-0 794 220) when large additions, e.g. 20%, of aluminium tris(ethylmethylphosphinate) are made to a polyester formulation reinforced with 30% of glass fibres are low; well below 600 V.

US-A-2005 013 7297 mentions, in another context, a flame-retardant polyester formulation which comprises not only zinc phosphinate and a nitrogen-containing flame retardant, such as melamine cyanurate, but also from 0.1 to 15% of a carbonizing polymer, preferably based on polyetherimides or on polyphenylene systems. However, here again the IZOD impact resistances stated for formulations with, for example, 30% by weight of glass-fibre reinforcement and UL 94 V-0 (1.6 mm) classification are at most 30 kJ/m² to ISO 180/1U. For formulations with UL 94 V-0 at 0.8 mm, impact resistance indeed falls to values below 23 kJ/m², giving a very restricted application profile, UL 94 V-0 is a standardised test procedure for the testing of flame retardancy, and is described in more detail in the introduction.

It was therefore an object of the present invention to provide halogen-free flame retardancy for a polyester formulation with a metal phosphinate which is fusible under conventional processing conditions, so that this can be used to produce mouldings which not only have UL 94 V-0 classification at least 1.6 mm wall thickness hut also have good mechanical and electrical properties, examples of particularly important criteria here being IZOD impact resistance (to ISO 180 I/U>30 kJ/m²), outer fibre strain (>2.2% to ISO 178) and tracking resistance (CTI A of 600 volts). Another object of the present invention was a reproducible pass in the GWIT test to IEC 60695-2-13 at a glow-wire temperature of at least 750° C.

The IEC 60695-2-13 GWIT test is a standardized test for glow-wire resistance and is described in more detail m the Examples section.

Surprisingly, it has now been found that the desired properties can be very substantially achieved if the polyester moulding compositions comprise not only a specific combination composed of fusible metal phosphinate and nitrogen-containing flame retardants but also a specific mixture composed of polybutylene terephthalate and of at least one further thermoplastic polyester other than polybutylene terephthalate, with the possibility of achieving additional improvement in properties by using certain inorganic metal salts.

The invention therefore provides thermoplastic moulding compositions comprising
A) from 1 to 95% by weight of a thermoplastic polyester other than polybutylene terephthalate,
B) from 1 to 95% by weight of a thermoplastic polybutylene terephthalate,
C) from 1 to 30% by weight of one or more phosphide sails of the (I) and/or of one or more diphosphinic salts of the formula (II) and/or their polymers

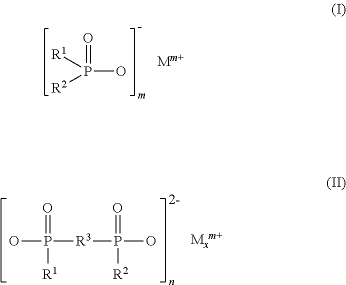

with the property of melting at temperatures below 310° C., preferably below 280° C., particularly preferably below 25° C., very particularly preferably below 220° C., and in which
R¹ and R² are identical or different and are hydrogen and/or linear or branched C₁-C₂₀-alkyl, and/or aryl,
R³ is linear or branched C₁-C₁₈-alkylene, C₆-C₁₀-arylene or C₁-C₆-alkylarylene or aryl-C₁-C₆-alkylene,
M is alkaline earth metals, alkali metals, aluminium, zinc, titanium, zirconium, silicon, tin and/or a protonated nitrogen base,
m is from 1 to 4,
n is from 1 to 3 and
x is 1 or 2,
D) from 0.5 to 25% by weight, preferably from 1 to 20% by weight, particularly preferably from 5 to 15% by weight, of at least orse reaction product of s nitrogen-containing compound with phosphoric acid or with condensed phosphoric acids.

In one preferred embodiment, the thermoplastic moulding compositions can comprise E) from 0.1 to 10% by weight, preferably from 0.5 to 5% by weight, particularly preferably from 0.75 to 3.5% by weight of at least one oxygen-, nitrogen- or sulphur-containing metal compound, preferably of the second main or transition group, particularly preferably Ca, Mg or Zn, very particularly preferably zinc oxide and/or zinc sulphide, in addition to components A) to D).

In another preferred embodiment, the thermoplastic moulding compositions can comprise component F) from 0.1 to 60% by weight, preferably from 1 to 50% by weight, particularly preferably from 10 to 40% by weight, of one or more fillers and reinforcing materials, in addition to components A) to E) or instead of E).

In another preferred embodiment, the thermoplastic moulding compositions can comprise G) from 0.01 to 5% by weight, preferably from 0.05 to 3% by weight, particularly preferably from 0.1 to 2% by weight, of at least one lubricant and/or mould-release agent, in addition to components A) to F) or instead of E) or F).

In another preferred embodiment, the thermoplastic moulding compositions can comprise H) from 0.01 to 40% by weight, preferably from 0.01 to 20% by weight, particularly preferably from 0.1 to 15% by weight, in each case based on the entire composition, of further additives, in addition to components A) to G) or instead of components E), F) or G).

The total of the proportions of the components is always 100% by weight.

Thermoplastic polymers, according to Hans Domininghaus in “Die Kunststoffe und ihre Eigenschaften” [Plastics and their Properties], 5^{th} Edition (1998), p. 14, are polymers which soften when heated and can be moulded in almost any desired manner, and whose molecular chains have either no side branches or else varying numbers of relatively short or relatively long side branches.

According to the invention, the following combinations of the components are conceivable: ABCD, ABCDE, ABCDEF, ABCDEFG, ABCDF, ABCDFG, ABCDG, ABCDH, ABCDEG, ABCDEH, ABCDFH, ABCDEFH, ABCDEGH, ABCDFGH, ABCDEFGH.

According to the invention, the thermoplastic moulding compositions comprise, as component A), at least one thermoplastic polyester, preferably semi aromatic polyester, other than polybutylene terephthalate.

The thermoplastic, preferably semiaromatic polyesters to be used according to the invention as component A) have been selected from the group of the polyalkylene terephthalates with the exception of the polybutylene terephthalates, preferably selected from the group of the polyethylene terephthalates and of the polytrimethylene terephthalates, particularly preferably of the polyethylene terephthalates.

Semiaromatic polyesters are materials whose molecules contain not only aromatic moieties but also aliphatic moieties.

For the purposes of the invention, polyalkylene terephthalates are reaction products of aromatic dicarboxylic acids or of their reactive derivatives (e.g. dimethyl esters or anhydrides) with aliphatic, cycloaliphatic or araliphatic diols, and mixtures of these reaction products.

Polyalkylene terephthalates to be used with preference according to the invention can be prepared from terephthalic acid (or from its reactive derivatives) with aliphatic or cycloaliphatic diols having from 2 to 10 carbon atoms, by known methods (Kunstsloff-Handbuch [Plastics Handbook], Vol. VII, pp. 695 et seq., Karl-Hanser-Yerlag, Munich 1973).

Polyalkylene terephthalates to be used with preference according to the invention contain at feast 80 mol %, preferably 90 mol %, based on the dicarboxylic acid, of terephthalic acid moieties, and at least 80 mol %, preferably at least 90 mol %, based on the diol component, of ethylene glycol moieties and/or 1,3-propanediol moieties.

The polyalkylene terephthalates to be used with preference according to the invention can contain, alongside terephthalic acid moieties, up to 20 mol % of moieties of other aromatic dicarboxylic acids having from 8 to 14 carbon atoms or moieties of aliphatic dicarboxylic acids having from 4 to 12 carbon atoms, examples being moieties of phthalic acid, isophthalic acid, naphthalene-2,6-dicarboxylic acid, 4,4′-biphenyldicarboxylic acid, succinic acid, adipic acid, sebacic acid, azelaic acid, cyclohexanediacetic acid, cyclohexanedicarboxylic acid.

The polyalkylene terephthalates to be used with preference according to the invention can contain, alongside ethylene glycol moieties or alongside 1,3-propanediol glycol moieties, up to 20 mol % of other aliphatic diols having from 3 to 12 carbon atoms, or cycloaliphatic diols having from 6 to 21 carbon atoms, examples being moieties of 1,4-butanediol, 2-ethyl-1,3-propanediol, neopentyl glycol, 1,5-pentanediol, 1,6-hexanediol, 1,4-cyclohexanedimethanol, 3-methyl -2,4-pentanediol, 2-methyl-2,4-pentanediol, 2,2,4-trimethyl-1,3-pentanediol, 2-ethyl-1,3-hexanediol and 2-ethyl-1,6-hexanediol, 2,2-diethyl-1,3-propanediol, 2,5-hexanediol, 1,4-di(β-hydroxyethoxy)benzene, 2,2-bis(4-hydroxycyelohexy)propane, 2,4-dihydroxy-1,1,3,3-tetramethylcyclobutane, 2,2-bis(3-β-hydroxyethoxphenyl)propane or 2,2-bis(4-hydroxypropoxyphenyl)propane (DE-A 24 07 674 (=U.S. Pat. No. 4,035,958), DE-A 24 07 776, DE-A 27 15 932 (=U.S. Pat. No. 4, 176,224)).

The polyalkylene terephthalates to be used according to the invention can be branched by incorporating relatively small amounts of tri- or tetrahydric alcohols, or of tri- or tetrabasic carboxylic acids, examples being those described in DE-A 19 00 270 (=U.S. Pat. No. 3,692,744). Examples of preferred branching agents are trimesic acid, trimellitic acid, trimethylolethane and -propane and pentaerythritol.

It is advisable to avoid using more than 1 mol % of the branching agent, based on the acid component.

According to the invention, particular preference is given to polyalkylene terephthalates which are prepared solely from terephthalic acid and from its reactive derivatives (e.g. its dialkyl esters) and from ethylene glycol and/or from 1,3-propanediol(polyethylene terephthalate and polytrimethylene terephthalate), and to mixtures of these polyalkylene terephthalates.

Other polyalkylene terephthalates to be used with preference according to the invention are copolyesters which are prepared from at least two of the abovementioned acid components and/or from at least two of the abovementioned alcohol components and/or from 1,4-butanediol. Particularly preferred copolyesters are poly(ethylene glycol/1,4-butanediol) terephthalate.

The intrinsic viscosity of the polyalkylene terephthalates is generally about 0.3 cm³/g to 1.5 cm³/g, preferably 0.4 cm³/g to 1.3 cm³/g, particularly preferably 0.5 cm³/g to 1.0 cm³/g, measured in each case in phenol/o-dichlorobenzene (1:1 parts by weight) at 25° C.

The thermoplastic polyesters to be used according to the invention as component A) can also be used in a mixture with other polyesters and/or further polymers.

According to the invention, the thermoplastic moulding compositions comprise polybutylene terephthalate as component B).

For the purposes of the invention, polybutylene terephthalates can be prepared from terephthalic acid (or its reactive derivatives) and 1,4-butanediol, by known methods (Kunststoff-Handbuch [Plastics Handbook], Vol. VIII, pp. 695 et seq., Karl-Hanser-Verlag, Munich 1973).

Preferred polybutylene terephthalates contain at least 80 mol %, preferably 90 mol %, based on the dicarboxylic acid, of terephthalie acid moieties and at least 80 mol %, preferably at least 90 mol %, based on the diol component, of 1,4-butanediol moieties.

The preferred polybutylene terephthalates can contain, alongside terephthalie acid moieties, up to 20 mol % of moieties of other aromatic dicarboxylic acids having from 8 to 14 carbon atoms or moieties of aliphatic dicarboxylic acids having from 4 to 12 carbon atoms, examples being moieties of phthalic acid, isophthalic acid, naphthalene-2,6-dicarboxylic acid, 4,4′,-biphenyldicarboxylic acid, succinic acid, adipic acid, sebacic acid, azelaic acid, cyclohexanediacetic acid, cyclohexanedicarboxylic acid.

The preferred polybutylene terephthalates can moreover contain, alongside 1,4-butanediol moieties, up to 20 mol % of other aliphatic diols having from 2 to 12 carbon atoms or cycloaliphatic diols having from 6 to 21 carbon atoms, e.g. moieties of ethylene glycol, 1,3-propanediol, 2-ethyl -1,3-propanediol, neopentyl glycol, 1,5-pertanediol, 1,6-hexanediol, 1,4-cyclohexanedimethanol, 3-methyl-2,4-pentanediol, 2-methyl-2,4-pentanediol, 2,2,4trimethyl-1,3-pentanediol, 2-ethyl-1,3-hexanediol and 2-ethyl-1,6-hexanediol, 2,2-diethyl-1,3-propanediol, 2,5-hexanediol, 1,4-di(β-hydroxyethoxy)benzene, 2,2-bis(4-hydroxycyclohexyl)propane, 2,4-dihydroxy-1,1,3,3-tetramethylcyclobutane, 2,2-bis(3-β-hydroxyethoxyphenyl)propane and 2,2-bis(4-hydroxypropoxyphenyl)propane (DE-A 24 07 674(=U.S. Pat. No. 4,035,958), DE-A 24 07 776, DE-A 27 15 932 (=U.S. Pat No. 4,176,224)).

The polybutylene terephthalates can be branched by incorporating relatively small amounts of tri- or tetrahydric alcohols, or of tri- or tetrabasic carboxylic acids, examples being those described in DE-A 19 00 270 (=U.S. Pat. No. 3,692,744). Examples of preferred branching agents are trimesic acid, trimellitic acid, trimethylolethane and -propane and pentaerythritol.

It is advisable to avoid using more than 1 mol % of the branching agent, based on the acid component.

Particular preference is given to polybutylene terephthalates which are prepared solely from terephthalic acid and from its reactive derivatives (e.g. from its dialkyl esters) and from 1,4-butanediol.

The intrinsic viscosity of the polybutylene terephthalates to be used as component B) is generally about 0.3 cm³/g to 1.5 cm³/g, preferably 0.4 cm³/g to 1.3 cm³/g, particularly preferably 0.5 cm³/g to 1.0 cm³/g, measured in each case in phenol/o-dichlorobenzene (1:1 parts by weight) at 25° C.

According to the invention, the moulding compositions comprise, as component C), one or more phosphinic salts of the formula (I) and/or one or more diphosphinic salts of the formula (II) and/or their polymers, with the property of melting at temperatures below 310° C., preferably below 280° C., particularly preferably below 250° C., very particularly preferably below 220° C., and in which
R¹ and R² are identical or different and are hydrogen and/or linear or branched C¹-C²⁰-3, and/or aryl,
R³ is linear or branched C₁-C₁₀-alkylene, C₆-C₁₀-arylene or C₁-C₆-alkylene,
M is alkaline earth metals, alkali metals, aluminium, zinc, titanium, zirconium, silicon, tin and/or a protonated nitrogen base,
m is from 1 to 4,
n is from 1 to 3 and
x is 1 or 2.

M is preferably magnesium, calcium, aluminium, titanium and/or line, particularly preferably zinc or titanium, very particularly preferably zinc, Protonated nitrogen bases are preferably the protonated bases of ammonia, 1,3,5-triazine compounds and triethanolamine, and particularly preferably melamine. It is preferable that R¹ and R², identical or different, are linear or branched C₁-C₁₈-alkyl and/or phenyl. It is particularly preferable that R¹ and R², identical or different, are methyl, ethyl, n-propyl, isopropyl, n-butyl, tert-butyl, n-pentyl and/or phenyl. It is preferable that R³ is methylene, ethylene, n-propylene, isopropylene, n-butylene, tert-butylene, n-pentylene, n-octylene, n-dodecylene, phenylene, naphthylene, methylphenylene, ethylphenylene, tert-butylphenylene, methylnaphthylene, ethylnaphthylene, tert-butylnaphthylene, phenylmethylene, phenylethylene, phenylpropylene or phenylbutylene. It is particularly preferable that R³ is phenylene or naphthylene. Suitable phosphinates are described in WO-A 97/39053, the content of which in relation to the phosphinates is incorporated into the present application. WO 97/39 053 uses the expression “phosphinic acid salt” for salts of phosphinic and of diphosphinic acids and their polymers.

The phosphinic salts prepared in an aqueous medium are accordingly in essence monomelic compounds. As a function of the reaction conditions, polymeric phosphinic salts can also be produced in some circumstances.

According to WO 97/39 053, examples of suitable phosphinic acids as constituent of the phosphinic salts are:

dimethylphosphinic acid, ethylmethylphosphinic acid, diethylphosphinic acid, methyl-n-propylphosphinic acid, methanedi(methylphosphinic acid), benzene-1,4-(dimethylphosphinic acid), methylphenylphosphinic acid, diphenylphosphinic acid. The salts of the phosphinic acids can be prepared by known methods, which are described in more detail in EP-A-699 708. The phosphinic acids here are reacted in aqueous solution with metal carbonates, with metal hydroxides or with metal oxides. For the purposes of the present invention, therefore, particularly preferred phosphinates are zinc salts of dimethylphosphinic acid, of ethylmethylphosphinic acid, of diethylphosphinic acid, and of methyl-n-propylphosphinic acid, and also their mixtures. Very particular preference is given to the zinc salts of diethylphosphinic acid (zinc bis[diethylphosphinate]).

m is preferably 2 or 3, particularly preferably 2.

n is preferably 1 or 3, particularly preferably 1.

x is preferably 1 or 2, particularly preferably 1.

The moulding compositions comprise, as component D) to be used according to the invention, at least one reaction product of a nitrogen-containing compound with phosphoric acids or with condensed phosphoric acids.

Preferred nitrogen-containing compounds for these reaction products are allantoin, ammonia, benzoguanamine, dicyandiamide, guanidine, glycol urils, urea and melamine, condensates of melamine, e.g. melem, melam or melon, and also derivatives of these compounds, e.g. their species substituted on nitrogen.

For the purposes of the invention, particular phosphoric acids or condensed phosphoric acids are phosphoric acid, diphosphoric acid, and meta- and polyphosphoric acid.

Component D) is particularly preferably reaction products of melamine with phosphoric acid or with condensed phosphoric acids, or reaction products of condensates of melamine with phosphoric acid or with condensed phosphoric acids, or else a mixture of the products mentioned. The reaction products with phosphoric acids here are compounds which are produced via reaction of melamine or of the condensed melamine compounds melam, melem or melon, etc., with phosphoric acid or with condensed phosphoric acids. Examples of these are dimelamine phosphate, dimelamine pyrophosphate, melamine phosphate, melamine pyrophosphate, melamine polyphosphate, melam polyphosphate, melon polyphosphate and melem polyphosphate, and mixed polysalts, examples being those, described in WO-A 98/39306 (=U.S. Pat. No. 6,136, 973). Component D) is very particularly preferably melamine polyphosphate. Melamine polyphosphate is available commercially in a variety of product qualities. Examples here include Mefapur® 200/70 (from the company CIBA Melapur, Basle, Switzerland) and also Budit® 3141 (from the company Budenheim, Budenheim, Germany).

The inventive compositions can, if appropriate, comprise at least one oxygen-, nitrogen- or sulphur-containing metal compound, as component E). According to the invention, examples of these are boron nitride, titanium nitride, titanium dioxide and boehmite, in particular nano-scale boehmite. Other preferred metal compounds are those of the second main or transition group among these, according to the invention, are ZnO, in particular activated ZnO (e.g. from the company Bayer AG, Leverkusen, Germany), ZnS, MgCO₃, CaCO₃, zinc borate, CaO, MgO, Mg(OH)₂, Mg₃N₂, Zn₃(PO₄)₂, Ca₃(PO₄)₂, calcium borate, magnesium borate and their mixtures. Particularly preferred metals according to the invention are Ca, Mg or Zn, particular preference being given to zinc borate and zinc sulphide, and very particular preference being given here to zinc sulphide. The zinc sulphide is generally used in the form of particulate solid. The expression zinc borate is intended for the purposes of the present invention to mean substances which are obtainable from zinc oxide and boric acid. Various hydrates of zinc borate are known, examples being ZnO.B₂O₃.2H₂O and 2ZnO.3B₂O₃.3.5H₂O, and preference is given here to compounds of the two abovementioned constitutions. Examples of zinc borate that can be used are described in Gmelin system No. 32, Zn, 1924, , p. 248, Supplementary Volume, 1956, pp. 971-972, Kirk-Othmer (4th) 4, 407-408, 10, 942; Ullmann (5th) A 4, 276; Winnacker-Küehler (4th) 2, 556.

Components E) can also be used in the form of compacted material or else in the form of masterbatches in a polymeric carrier material. Components E) can moreover have been surface-treated or can have been coated with known agents. Among these are, inter alia, organic compounds which can be applied in monomeric, oligomeric and/or polymeric form. Coatings with inorganic components are likewise possible.

In one preferred embodiment, the moulding compositions can also comprise, as component F), fillers and reinforcing materials, in addition to components A) to D) and, if appropriate, E). However, it is also possible that a mixture is present composed of two or more different fillers and/or reinforcing materials, for example those based on talc, mica, silicate, quartz, titanium dioxide, wollastonite, kaolin, amorphous silicas, magnesium carbonate, chalk, feldspar, barium sulphate, glass beads and/or fibrous fillers and/or reinforcing materials based on carbon fibres and/or glass fibres. It is preferable to use mineral particulate fillers based on talc, mica, silicate, quartz, titanium dioxide, wollastonite, kaolin, amorphous silicas, magnesium carbonate, chalk, feldspar, barium sulphate and/or glass fibres. According to the invention, it is particularly preferable to use mineral particulate fillers based on talc, wollastonite, kaolin and/or glass fibres.

Particularly for applications in which isotropy of dimensional stability and high thermal dimensional stability are demanded, examples being motor vehicle applications for exterior bodywork parts, it is preferable to use mineral fillers, in particular talc, wollastonite or kaolin.

It is also particularly preferable to use acicular mineral fillers as component F). According to the invention, acicular mineral tillers is the term for a mineral filler with pronounced acicular character, Acicular wollastonites may be mentioned as an example. The length:diameter ratio of the mineral is preferably from 2:1 to 35:1, particularly preferably from 3:1to 19:1, most preferably from 4:1 to 12:1. The average particle size of the inventive acicular minerals is preferably smaller than 20 μm, particularly preferably smaller than 15 μm, with particular preference smaller than 10 μm, determined using a CILAS GRANULOMETER.

The filler and/or reinforcing material can, if appropriate, have surface modification, for example with a coupling agent or coupling agent system, based on silane for example. However, pre-treatment is not essential. Particularly when glass fibres are used, it is also possible to use, in addition to silanes, polymer dispersions, film-formers, branching agents and/or glass fibre processing aids.

The glass fibres to be used with particular preference according to the invention, if appropriate, as component F) their fibre diameters generally being from 7 to 18 μm, preferably from 9 to 15 μm, are added in the form of continuous-filament fibres or in the form of chopped or ground glass fibres. The fibres can have been equipped with a suitable size system and with a coupling agent or coupling agent system, based on silane for example.

Commonly used coupling agents based on silane for pre-treatment are silane compounds such as those of the general formula (I)

(X—(CH₂)_{q})ₖ—Si—(O—CH₁H₂ₓ₊₁)₄₋ₖ (I)

in which the substiuents are defined as follows:

X: NH₂—, HO—,

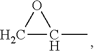

q: a whole number from 2 to 10, preferably from 3 to 4,

r: a whole number from 1 to 5, preferably from 1 to 2,

k: a whole number from 1 to 3, preferably 1.

Preferred coupling agents are silane compounds from the group of aminopropyltrimethoxysilane, aminobutyltrimethoxysilane, aminopropyltriethoxysilane, aminobutyltriethoxysilane, and the corresponding silanes which contain a glycidyl group as substituent X.

The amounts generally used of the silane compounds for surface treatment of the fillers are from 0.05 to 2% by weight, preferably from 0.25 to 1.5% by weight and in particular from 0.5 to 1% by weight, based on the mineral filler.

Processing to give the moulding composition or to give the moulding can have the effect that the d97 value or d50 value of the particulate fillers in the moulding composition or in the moulding is smaller than that of the fillers originally used. Processing to give the moulding composition or to give the moulding can have the effect that the length distributions of the glass fibres in the moulding compositions or in the moulding are shorter than those originally used.

In another alternative preferred embodiment, the moulding compositions can also comprise at least one lubricant and mould-release agent as component G), in addition to components A) to D) and, if appropriate, E) and/or F). Examples of materials suitable for this purpose are long-chain fatty acids (e.g. stearic acid or behenic acid), their salts (e.g. Ca stearate or Zn stearate), and also their ester derivatives or amide derivatives (e.g. ethylenebisstearylamide), Montan waxes (mixtures composed of straight-chain, saturated carboxylic acids having chain lengths of from 28 to 32 carbon atoms), and also low-molecular-weight polyethylene waxes and low-molecular-weight polypropylene waxes. According to the invention, it is preferable to use lubricants and/or mould-release agents from the group of the low-molecular-weight polyethylene waxes, and also of the esters of saturated or unsaturated aliphatic carboxylic acids having from 8 to 40 carbon atoms with saturated aliphatic alcohols having from 2 to 40 carbon atoms, and very particular preference is given here to pentaerythrityl tetrastearate (PETS).

In another alternative preferred embodiment, the moulding compositions can also comprise further additives as component H), in addition to components A) to D) and, if appropriate, E) and/or F) and/or G). Examples of conventional additives are stabilizers (for example UV stabilizers, heat stabilizers, gamma-ray stabilizers, hydrolysis stabilizers), antistatic agents, further flame retardants, emulsifiers, nucleating agents, plasticizers, processing aids, impact modifiers, dyes and pigments. The additives mentioned and further suitable additives are described by way of example in Gächter, Müller, Kunststoff-Additive [Plastics Additives], 3^{rd} Edition, Hanser-Verlag, Munich, Vienna, 1989 und im Plastics Additives Handbook, 5th Edition, Hanser-Verlag, Munich, 2001. The additives can be used alone or in a mixture or in the form of masterbatches, or can be admixed in advance with component A) in the melt, or applied to its surface.

Examples of stabilizers that can be used are sterically hindered phenols and/or phosphites, hydroquinones, aromatic secondary amines, such as diphenylamines, substituted resorcinols, salicylates, benzotriazoles and benzophenones, and also various substituted representatives of these groups and their mixtures.

UV stabilizers that may be mentioned are various substituted resorcinols, salicylates, benzotriazoles and benzophenones.

Impact modifiers (elastomer modifiers, modifiers) are very generally copolymers preferably composed of at least two of the following monomers: ethylene, propylene, butadiene, isobutene, isoprene, chloroprene, vinyl acetate, styrene, acrylonitrile and acrylic or methacrylic esters having from 1 to 18 carbon atoms in the alcohol component.

Colourants that can be added are inorganic pigments, such as titanium dioxide, ultramarine blue, iron oxide, zinc sulphide and carbon black, and also organic pigments, such as phthalocyanines, quinacridones, perylenes and also dyes, such as nigrosin and anthraquinones and also other colourants. For the purposes of the present invention, it is preferable to use carbon black.

Examples of nucleating agents that can be used are sodium phenylphosphinate or calcium phenylphosphinate, aluminium oxide or silicon dioxide and also preferably talc.

Examples of processing aids that can be used are copolymers composed of at least one α-olefin with at least one methacrylate or acrylate of an aliphatic alcohol. Preference is given here to copolymers in which the α-olefin is composed of ethene and/or propene and the methacrylate or acrylate contains, as alcohol component, linear or branched alkyl groups having 4 to 20 carbon atoms, Butylacrylate or 2-ethylhexyl acrylate is particularly preferred.

Examples that may be mentioned of plasticizers are dioctyl phthalate, dibenzyl phthalate, butyl benzyl phthalate, hydrocarbon oils, N-(n-butyl)benzenesulphonamide.

Examples that may be mentioned of other flame retardants are phosphorus-containing flame retardants selected from the groups of the mono- and oligomeric phosphoric and phosphonic esters, phosphonate amines, phosphonates, phosphites, hypophosphites, phosphine oxides and phosphazenes, and it is also possible here to use, as flame retardant, a mixture of a number of components selected from one or from a variety of these groups. It is also possible to use other halogen-free phosphorus compounds not specifically mentioned here, alone or in any desired combination with other, preferably halogen-free phosphorus compounds. Among these are also purely inorganic phosphorus compounds, such as boron phosphate hydrate or red phosphorus. Further, nitrogen-containing, flame retardants that can be used are those from the group of the allantoin derivatives, cyanuric acid derivatives, dicyandiamide derivatives, glycoluril derivatives, guanidine derivatives, ammonium derivatives and melamine derivatives, preferably allantoin, benzoguanamine, glycoluril, melamine, condensates of melamine, e.g. melem, melam or melon, or compounds of this type of a higher condensation level, and adducts of melamine with further acids, e.g. with cyanuric acid (melamine cyanurate). Examples of synergists that can be used are antimony compounds, in particular antimony trioxide, sodium antimonate and antimony pentoxide, and tin compounds, e.g. tin stannate and tin borate. It is also possible to use salts of aliphatic and of aromatic sulphonic acids, and to use mineral flame retardant additives, such as aluminium hydroxide and/or magnesium hydroxide, Ca—Mg carbonate hydrates (e.g. DE-A 4 236 122 molybdenum oxide or else zinc salts and magnesium salts. Other suitable flame retardant additives are carbonisers, such as phenol-formaldehyde resins, polycarbonates, polyphenyl ethers, polyimides, polysulphones, polyether sulphones, polyphenyl sulphides and polyether ketones and also antidrip agents, such as tetrafluoroethylene polymers.

However, the present invention also provides the fibres, foils and mouldings obtainable via conventional industrial processes from the thermoplastic moulding compositions described according to the invention and comprising components A) to D), and also in preferred embodiments, if appropriate, E), F), G) and/or H).

Finally, the present invention also provides a process for the production of fibres, foils and mouldings, characterized in that moulding compositions comprising components A to D), and also in preferred embodiments, if appropriate, E), F), G) and/or H), are used.

The inventive moulding compositions can be processed by conventional processes, for example via injection moulding or extrusion, to give mouldings, fibres or semifinished products. Examples of semifinished products are foils and sheets. Processing via injection moulding is particularly preferred.

The mouldings or semifinished products to be produced according to the invention from the thermoplastic moulding compositions can be small or large parts and, by way of example, can be used in the motor vehicle, electrical, electronics, telecommunications, information technology, entertainment, or computer industry, or in vehicles and other conveyances, in ships, in spacecraft, and in households, in office equipment, in sport, in medicine, and also generally in articles and pans of buildings which require increased fire protection.

A further example of an application is the processing of the moulding compositions by way of what are known as multitooling systems, in which material is charged by way of a runner system to at least 4 moulds, preferably at least 8 moulds, particularly preferably at least 12 moulds, most preferably at least 16 moulds, in an injection moulding procedure.

The present invention is described with reference to specific details and examples of particular embodiments thereof. It is not intended that such details be regarded as limitations upon the scope of the invention except insofar as and to the extent that they are expressly included in the accompanying claims.

As used in this specification and the appended claims, the singular forms “a,” “an,” and “the” include plural referents unless the content clearly dictates otherwise.

### EXAMPLES

In order to demonstrate the improvements described according to the invention in flame retardancy and mechanical properties, compounding was first used to prepare appropriate plastics moulding compositions. To this end, the individual components were mixed in a twin-screw extruder (ZSK 32 Mega Compounder from Coperion Werner & Pfleiderer (Stuttgart, Germany)) at temperatures from 270 to 335° C., and extruded and cooled until they could be pelletized. After drying (generally 2 hours at 120° C. in a vacuum drying cabinet) the pellets were processed to give test specimens.

The test specimens for the tests listed in Tables 1-2 were injection-moulded at a melt temperature of about 27° C. and a mould temperature of about 90° C. in an Arburg 320-210-500 injection moulding machine;
80×10×4 mm test specimens (to ISO 178 or ISO 180/1U)
ASTM standard test specimens for the UL 94 V test
test specimens for the DIN EN 60695-2-1 glow-wire test

The flame retardancy of the moulding compositions was firstly determined by the UL 94 V method (Underwriters Laboratories Inc. Standard of Safety, “Test for Flammability of Plastic Materials for Parts in Devices and Appliances”, p. 14 to p. 18 Northbrook 1998).

Glow-wire resistance was determined by the IEC 60695-2-12 GWFI (Glow Wire Flammability Index) test, arid also by the 60695-2-13 GWIT (Glow Wire Ignition Temperature) test. In the GWFI test, a glowing wire is used at temperatures of from 550 to 96° C. to determine, on 3 test specimens (e.g. 60×60×1.5 mm), the maximum temperature at which an afterflame time of 30 seconds is not exceeded and no flaming drops come from the specimen, In the GWIT test, with a comparable test procedure, the glow-wire ignition temperature is stated, being higher by 25 K (30 K at from 900° C. to 960° C.) than the maximum glow-wire temperature which in 3 successive tests does not cause ignition even during the time of exposure to the glow wire. Ignition here means a flame with flame time ≧5 sec.

Mechanical properties are obtained from IZOD impact resistance measurements (ISO 180/IU, 23° C.) or from flexural tests to ISO 178 (flexural modulus, outer fibre strain and flexural strength).

The following were used in the tests:

Component A: linear polyethylene terephthalate with intrinsic viscosity of about 0.74 cm³/g (measured in phenol: 1.2-dichlorobenzene=1:1 at 25° C.)

Component B: linear polybutylene terephthalate (Pocan® B 1300, commercially available product from Lanxess Deutschland GmbH, Leverkusen, Germany) with intrinsic viscosity of about 0.93 cm³/g (measured in phenol: 1.2-dichlorobenzene=1: at 25° C.)

Component C: zinc bis[diethylphosphinate] (Exolit® OP950 from the company Clariant GmbH, Frankfurt am Main, Germany)

Component comp./1: system according to formula (I), where R¹=R²=ethyl and M=aluminium [according to EP-A 803508/EP-A 944637]

Component comp./2: melamine eyanurate, (Melapur®, from the company CIBA, Basle, Switzerland)

Component D: melamine polyphosphate (Melapur®, 200/70 from the company CIBA, Basle, Switzerland)

Component E: zinc sulphide

Component F: glass fibre with diameter 10 μm (CS 7967, commercially available product from the company Lanxess N.V., Antwerp, Belgium) sized with silane-containing compounds

Component G: mould-release agent commonly used in thermoplastic polyesters, e.g. polyethylene wax or pentaerythrityl tetrastearate (PETS)

The nature and amount of the mould-release agents used (component G) are in each case the same for corresponding comparative examples and inventive examples, and specifically with G=0.3.

Component H: further additives

Further additives used comprise the following components commonly used in thermoplastic polyesters:

nucleating agent: amounts of from 0.05 to 0.65% by weight of talc [CAS No. 14807-96-6].

Heat stabiliser: amounts of from 0.05 to 0.65% by weight of conventional stabilizers based on phenyl phosphates

The nature and amount of the further additives used (component H) are in each case the same for corresponding comparative examples and inventive examples, and specifically with H=0.7% by weight.

The total of the proportions of the components is 100% by weight.

TABLE 1

| | Imv. | Imv. | Comp. | Comp. |
|---|---|---|---|---|
| Component | Ex. 1 | Ex. 2 | Ex. 3 | Ex. 4 |
| A | 19 | 19 | 20 | 19 |
| B | 29.5 | 29.5 | 29 | 29 |
| C | 10 | 8 | 10 | 10 |
| comp./1 | | | | |
| D | 10 | 12 | | |
| comp./2 | | | 10 | 15 |
| E | 0.5 | 0.5 | | |
| F | 30 | 30 | 30 | 30 |
| G | 0.3 | 0.3 | 0.3 | 0.3 |
| H | 0.7 | 0.7 | 0.7 | 0.7 |
| UL 94 (0.8/1.6 mm) | V-2/V-0 | V-0/V-0 | /n.d. | —/V-2 |
| GWFI (1.5 mm) | 960° C. | 960° C. | 960° C. | 960° C. |
| | | | (2.1) | |
| GWIT (1.5 min) | 775° C. | 960° C. | | >775° C. |
| CTI A [volts] | 600 | 600 | | — |
| IZOD impact resistance | 46 kJ/m² | 33 kJ/m² | 37.3 kJ/m² | 29 kJ/m² |
| (ISO 180/1 U 23° C.) | | | | |
| Flexural strength [MPa] | 185 | 170 | 175 | 158 |
| Outer fibre strain for | 2.9 | 2.3 | 2.3 | 2.0 |
| maximum force [%] | | | | |
| Flexural modulus [MPa] | 9700 | 9600 | 9800 | 10 600 |

Data for components in % by weight, based on entire moulding composition

TABLE 2

| Component | Comp. Ex. 5 | Comp. Ex. 6 | Comp. Ex. 7 |
|---|---|---|---|
| A | 20 | 20 | 0 |
| B | 29 | 26.5 | 49 |
| C | | | |
| comp./1 | 6.5 | 22.5 | 10 |
| D | 3.5 | | |
| comp./2 | 10 | | 10 |
| E | | | |
| F | 30 | 30 | 30 |
| G | 0.3 | 0.3 | 0.3 |
| H | 0.7 | 0.7 | 0.7 |
| UL 94 (0.8/1.6 mm) | V-2/V-0 | V-0/V-0 | V-0/V-0 |
| GWFI (1.5 mm) | 960° C. | — | — |
| GWIT (1.5 mm) | 750° C. | >775° C. | — |
| CTI A [volts] | 500 | — | — |
| IZOD impact resistance | 29 kJ/m² | 26 kJ/m² | 23 kJ/m² |
| (ISO 180/1 U 23° C.) | | | |
| Flexural strength [MPa] | 175 | 153 | 137 |
| Outer fibre strain for | 1.9 | 1.7 | 1.9 |
| maximum force [%] | 6.5 | | |
| Flexural modulus [MPa] | 11 300 | 11 300 | 10 300 |

Tables 1 to 2 show that very good values in comparison with the prior art are obtained for both flame retardancy (UL94 V-0 and GWIT 775° C. at least for 1.5 mm) and mechanical properties (IZOD impact resistance >31 kl/m² and outer fibre strain at least 2.3%) only with the specific inventive combination in Inv. Ex. 1 and 2. If component D is replaced by comp./2, compliance with UL94 V-0 is then no longer achieved even if the concentration of comp./2 is increased [Comp. Ex. 3 and 4]. Although replacement of C and D by comp./1 leads to good flame retardancy, there is a drastic reduction here in outer fibre strain and impact resistance [Comp. Ex, 6]. Same also applies to combinations of comp./1, D and comp./2 in [Comp. Ex. 5]. Another fact to be emphasized is that although a combination according to the prior art of comp./1 and comp./2, but omitting component A, likewise exhibits good flame retardancy properties, it is highly unsatisfactory in respect of mechanical properties and impact resistance [Comp. Ex. 7].

What is claimed is:

1. A thermoplastic moulding composition comprising the following components:
A) a thermoplastic material selected from the group consisting of a mixture of polyethylene terephtalate and polybutylene terephthalate,
wherein said polyethylene terephtalate and said polybutylene terephthalate are each present in an amount of from 1 to 95% by weight,
C) from 1 to 30% by weight of zinc bis-diethyiphosphinate,
D) from 0.5 to 25% by weight of melamine polyphosphate,
E) from 0.1 to 10% by weight of zinc sulphide, and
G) from 0.01 to 5% by weight of at least one lubricant and/or mould-release agent.

2. The thermoplastic moulding composition according to claim 1, further comprising component:
F) from 0.1 to 60% by weight of at least one glass fiber equipped with a coupling agent system based on silane.

3. The thermoplastic moulding composition according to claim 2, wherein the coupling agent based on silane comprises a silane compound of the general formula (III)
(X—(CH₂)_{q})ₖ—Si—(O—CᵣH₂ₓ₊₁)₄₋ₖ (III)
wherein
X is NH₂—, HO—, and/or 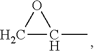
q is a whole number from 2 to 10,
r is a whole number from 1 to 5,
k is a whole number from 1 to 3.

4. The thermoplastic moulding composition according to claim 2, further comprising component:
H) from 0.01 to 40% by weight, in each case based on the entire composition, of further additives.

5. A process for the preparation of the thermoplastic moulding composition according to claim 1, comprising;
mixing the components A), C), D), E) and G) via melt extrusion.

6. A process for producing fibres, foils and mouldings containing the thermoplastic moulding composition according to claim 1, comprising:
providing the thermoplastic moulding composition to an injection moulding or extrusion apparatus, and moulding or extruding said thermoplastic moulding composition.

7. A process for producing mouldings containing the thermoplastic moulding composition according to claim 1, comprising:
providing the thermoplastic moulding composition to a multitooling apparatus having at least 4moulds via a runner system, and
moulding said thermoplastic moulding composition.

8. The process according to claim 6, wherein the fibres, foils and mouldings are moulded or extruded into a form for use in households, in industry, in medicine, in motor vehicles, in aircraft, in ships, in spacecraft, in office equipment, and also in articles and buildings which require increased fire protection.

9. The thermoplastic moulding composition according to claim 1, wherein component D) is present in the amount of 1 to 20% by weight.

10. The thermoplastic moulding composition according to claim 1, wherein component D) is present in the amount of 5 to 15% by weight.
